(19) United States
(12) Patent Application Publication
(10) Pub. No.: US 2021/0396356 A1
(43) Pub. Date: Dec. 23, 2021

(54) HIGH VOLUME, FAST HYDROGEN FUELING OF A HEAVY-DUTY VEHICLE

(71) Applicants: Nel Hydrogen A/S, Herning (DK); Nikola Corporation, Phoenix, AZ (US)

(72) Inventors: Thomas Christian Francois CHARBONNEAU, Toulouse (FR); Jesse Michael SCHNEIDER, Chandler, AZ (US)

(21) Appl. No.: 17/293,083

(22) PCT Filed: Nov. 20, 2019
(86) PCT No.: PCT/DK2019/050358

§ 371 Date: May 12, 2021

(30) Foreign Application Priority Data
Nov. 20, 2018 (DK) PA 2018 70761

(51) Int. Cl. F17C 7/00

(52) U.S. Cl. CPC F17C 7/00; F17C 2205/0142; F17C 2221/012; F17C 2250/032; F17C 2250/0443; F17C 2250/0434; F17C 2201/056; F17C 2201/054; F17C 2223/035; F17C 2227/0157; F17C 2223/0123; F17C 2227/043; F17C 2250/0439; F17C 2270/0139; F17C 2270/0171; F17C 2270/0173; F17C 2270/0176; F17C 2270/0189; F17C 2265/065

(57) ABSTRACT

The present disclosure relates to systems and methods for fueling a tank of a heavy-duty vehicle having a total volume above 1000 liters with a gaseous hydrogen fuelin an accelerated manner An average slope of the mass flow of a first part of the fueling implemented as a first fueling method is higher than the slope of the mass flow of a second part of the fueling implemented as a second fueling method.

### TECHNICAL FIELD

The present disclosure relates to a method and a fueling station facilitating high volume, fast hydrogen fueling of a heavy-duty vehicle

### BACKGROUND

Hydrogen fueling stations are typically following the SAE J2601-1 fueling methodology and SAE J2799 communications standards for fast fueling a vehicle storage with gaseous hydrogen. During such fueling typically 4-7 kg of hydrogen is transferred from the hydrogen fueling station to the vehicle tank in about 4-5 minutes, similar to today's conventional fueling. The SAE J2601-1 fueling protocol describes to follow either so-called average pressure ramp rate which suggests a substantial linear relationship between time and pressure of the fueling. Following that, each vehicle in the class of storage is fueled in the same rate. This uses an empirically based look up table to give targets for programmable logic controllers of hydrogen station dispensers with and without communications. The alternative method in SAE J2601-1, referred to as the “MC Method” uses heat capacity and real time temperature measurements from the hydrogen to optimize hydrogen fueling.

In the art, US20170051875 teaches how to supply hydrogen gas to a vehicle tank from a buffer tank of the hydrogen fueling station or from the supply storage via a compressor to the vehicle tank.

US20020014277 teaches to vary the average pressure ramp rate during the fueling based on pressure measured in the vehicle tank and EP1818597 teaches to use a first average pressure ramp rate for a first part of the fueling and a second average pressure ramp rate for a second part of the fueling.

The above-mentioned documents suffer from the fact that if a high volume gaseous fueling (such as with heavy duty vehicles) have to be made, time spend on such fueling easily reaches 20-40 minutes or even more. One way to reduce this time is to increase the volume of the hydrogen storage of the hydrogen fueling station, however this increases cost and footprint of the hydrogen fueling station. Accordingly, improved systems and methods for hydrogen fueling remain desirable.

### SUMMARY

The provides a method for fast fueling of a high volume of hydrogen into a high-volume tank of a heavy -duty vehicle e.g. transferring more than 20 Kg of gaseous hydrogen (such as 80 kg), within a time period of less than 15 minutes.

Accordingly, an exemplary embodiment relates to a method of fueling a tank of a heavy-duty vehicle with a gaseous hydrogen fuel; wherein the mass flow from a high-pressure hydrogen storage of a hydrogen fueling station to the tank is following a mass flow characteristic from start of the fueling at time Tstart to end of the fueling at time Tend, the method includes controlling, by a controller of the hydrogen fueling station, the slope of the mass flow characteristic between time Tstart and Tend, according to a first and a second fueling method, wherein the mass flow is established during a first period of time between Tstart and T1 by pressure difference between pressure of the hydrogen gas stored in the high-pressure hydrogen storage and pressure in the tank of the heavy-duty vehicle, wherein the mass flow is established during a second period of time between T1 and Tend by a compressor having an inlet fluidly connected to the high-pressure hydrogen storage and an outlet fluidly connected to the tank of the heavy-duty vehicle, wherein the average slope of the mass flow during the first period of time is higher than the average slop of the mass flow during the second period of time.

According to an exemplary embodiment, the average slope of the mass flow characteristics between Tstart and Tend of the mass flow characteristic is higher than a defined threshold of at least 60 grams per second [g/s], wherein an average slop of the mass flow characteristic during the first period from Tstart to T1 is higher than the average slope between Tstart and Tend, and wherein an average slop of the mass flow characteristic during a second period from T1 to Tend is lower than the average slope between Tstart and Tend.

Accordingly, a high volume, burst of gaseous hydrogen fuel is transferred from the fueling station to the vehicle tank within the first period. This is advantageous in that it has the effect, that to reach the average slope g/s denoted 12a of more than 60 gram/second (g/s) (which is much higher than specified in SAE J2601-1) between Tstart and Tend, requirements to the source of the gaseous fuel (preferably a compressor connected to the hydrogen storage) used during the second period can be reduced. Hydrogen fueling time and energy for the fueling process can be greatly reduced by having a burst of high mass flow hydrogen at the beginning of the fueling.

Accordingly, the invention at least solves the problem of facilitating a fast fueling of a large volume vehicle tank. The heat generated by this fast transfer of high volume of hydrogen gas is allowed due to the geometry of the vehicle tank i.e. larger planes to absorb heat and the large volume of the tank. A fueling of a light duty vehicle with the same high flow would require a significant cooling system to comply with temperature requirements.

This burst at the beginning of a fueling, i.e. within the first 3-4 minutes of a fueling of 10 minutes, has the advantage to quickly add heat to the hydrogen fuel as well as inner walls of the tanks. This higher, rapid temperature rise at the beginning of the fueling process allows for an overall lower amount of overall time to fuel as well as much less energy. Said in another way, it is advantageous to have the highest slope in the beginning of a refueling in that the inner walls of the tank at the beginning of a fueling are able to absorb more heat than at the end of a refueling. Accordingly, this high volume, fast fueling protocol is uniquely advantageous for large hydrogen storage.

Dividing the fueling into a first and a second period is advantageous in that it has the effect, that it is possible to supply the hydrogen gas from two different sources and thereby exploiting the best of two worlds so to speak (first period: high delta pressure leading to fast mass transfer in a short period of time; second period: constant pressure leading to a slower mass transfer, but for a long period of time).

To reach a total volume above 1000 liters, the hydrogen storage can be divided in one or more individual tanks the volume of which together sums up to above 1000 liters. The volume of a tank is defined downstream of the tank valve. The high volume of the tank is advantageous in that it has the effect that the area for absorbing heat is increased.

Heavy-duty vehicles are understood as buses, trains or trucks, but also aero planes and ships would be possible to refuel according to the above method and therefore fall under the definition of heavy-duty vehicles.

Flow path should be understood or implemented as pipes and valves through which gaseous hydrogen can flow.

According to an exemplary embodiment, the threshold value is above 100 g/s, preferably above 140 g/s most preferably above 180 g/s.

This is advantageous in that it has the effect, that as an example 80 Kg of hydrogen gas can be transferred to the tank in only 10 minutes or even 125 Kg of hydrogen gas can be transferred to the tank in only 15 minutes. Accordingly, it is advantageous in that this methodology enables fueling of e.g. a fuel cell truck in approximately the same time as fueling of a conventional fossil fuels, (Diesel, Gasoline or Natural Gas) internal combustion truck.

According to an exemplary embodiment, the average slope of the mass flow characteristics of the first period 12b is at least 4 times, preferably at least 6 times, most preferably at least 7 times higher than the slope of the mass flow characteristics of the second period 12c.

A slope during the first period 12b is at least a minimum 4 times to 7 times higher than the slope during the second period 12c is advantageous in that effectively more mass flow in a short amount of time is transferred. Further, it is advantageous in that it has the effect, that the capacity of the compressor used during the second period can be reduced.

According to an exemplary embodiment, the threshold value is predetermined for a predetermined type of vehicle tank.

This is advantageous in that it has the effect, that it is possible to predict the time for an 80 Kg fueling or the mass of hydrogen possible to transfer within e.g. 10 minutes.

According to an exemplary embodiment, the tank of the heavy-duty vehicle is a truck tank having a total volume above 1000 liters, preferable between 1000 L and 3000 L.

According to an exemplary embodiment, the tank is a train tank having a total volume above 4000 liters, preferably between 4000 L and 7000 L.

The size of the vehicle tanks is made with reference to H35 i.e. a nominal rating of 35 MPa. A suitable tank size is 2000 L for a truck embodiment and 6000 L for a train embodiment.

This is advantageous in that it has the effect, that pressure difference between initial pressure in the tank and the pressure in the high-pressure storage leads to a fast transfer (pressure balancing) of the gaseous fuel between the high-pressure storage and the tank. Fast here should be understood as faster than the threshold value i.e. higher than 60 g/s.

According to an exemplary embodiment, the high-pressure storage comprises a plurality of individual storage vessels.

This is advantageous in that it has the effect, that the high pressure e.g. above 700 bar can be established faster than in the situation where the high-pressure storage only comprises one vessel. Further, it facilitates replacement of individual vessels if needed.

According to an exemplary embodiment, the pressure of gaseous hydrogen in the individual vessels of the high-pressure storage is between 40 bar and 1000 bar.

The higher pressure the more advantageous in that it has the effect, that the average slope g/s denoted 12c then increases. Leading to reduced capacity to the supply of hydrogen during the second period.

Having a plurality of e.g. 1000 bar vessels, is advantageous in that it enables fueling according to the so-called cascade method where pressure balancing between each individual of the vessels and the tank is made sequentially. With this said an optimum between station cost (investment and operational) and fueling efficiency could point to a preferred storage pressure of e.g. 450 bar. With respect to operational cost a storage pressure of 450 bar has turned out to be optimal despite reduced capacity for the cascade furling during the first part of the fueling.

According to an exemplary embodiment, a vessel of the high-pressure hydrogen storage used as source of hydrogen gas in the first period is subsequently used as hydrogen source in the second period.

This is advantageous in that it has the effect, that such vessel can be emptied as much as possible thereby optimizing the hydrogen dump off while not slowing down the fueling i.e. keeping the average slopes at the mentioned levels.

According to an exemplary embodiment, the controller establishes flow from the individual vessels of the high-pressure hydrogen storage towards the nozzle in a sequence starting with the one of the vessels having the lowest pressure which is at least 25 bar, preferably at least 75 bar, most preferably at least 100 bar higher than the initial pressure in the tank of the heavy-duty vehicle. Typically, the pressure difference between the vessel having used for refueling and the pressure in the vehicle tank when the vessel change to a higher pressure vessel is between 20 bar and 50 bar to ensure high flow rate and efficient refueling.

This is advantageous in that it has the effect, that a substantial constant high pressure of gaseous hydrogen fuel can be maintained for a long period of time, at least until time Tend. It should be noted that a hydrogen storage is supplying hydrogen to the compressor which then is compressing it to a desired pressure for the tank.

According to an exemplary embodiment, the compressor facilitates supplying gaseous hydrogen fuel to the tank of the heavy-duty vehicle with at least an average between 50 g/s and 100 g/s, preferably between 65 g/s and 85 g/s during the second period from T1 to Tend.

Such a high capacity compressor is advantageous in that it has the effect, that the total average slope above the threshold can be established. When a total average slop denoted 12c above 130 g/s for a fueling is to be maintained, high capacity (such as 30 g/s) of the compressor is important if not additional compressors needs to be installed leading to increased costs of the hydrogen fueling station which naturally is not desired.

According to an exemplary embodiment, the method further comprises the step of determining the initial pressure inside the tank of the heavy-duty vehicle prior to time Tstart.

This is advantageous in that it has the effect, that prediction of heat generation can be made. The relationship between pressure increase and heat generation is logarithmic and therefore the heat generation as consequence of a pressure increase from 5 to 50 bar is the same as of a pressure increase from 50 to 500 bar. Therefore, especially in the beginning of the fueling it is relevant to know the pressure to be able to estimate and ensure that the temperature is kept below a design threshold level.

According to an exemplary embodiment, the method further comprises the step of attaching the nozzle to a receptacle of the heavy-duty vehicle and thereby establishing a flow path from the high-pressure hydrogen storage to the tank.

According to an exemplary embodiment, the method further comprises the step of initiating the fueling prior to attaching the nozzle to the receptacle.

According to an exemplary embodiment, the method further comprises the step of removing the nozzle from the receptacle after the time Tend.

According to an exemplary embodiment, the hydrogen source during the first period is refilled.

According to an exemplary embodiment, an additional compressor, during fueling of a vehicle tank, is performing pressure consolidation of a vessel of the hydrogen storage. If an additional compressor is available, then during the fueling, it is possible to increase the pressure of the individual vessels of the hydrogen storage. This is advantageous in that in this way the cascade method can be extended and the direct fill method can be made with a higher inlet pressure to the first compressor.

Moreover, an exemplary embodiment relates to a hydrogen fueling station facilitating fueling a tank of a heavy-duty vehicle having a total volume above 1000 liters with a gaseous hydrogen fuel, the hydrogen fueling station comprising: a high-pressure hydrogen storage, a high-pressure compressor, a controller, and a hydrogen flow path from the high-pressure hydrogen storage to a nozzle connectable to a receptacle of the heavy-duty vehicle. Wherein the hydrogen flow path comprises a first path by-passing the high-pressure compressor and a second path connecting the high-pressure compressor to the high-pressure hydrogen storage. Wherein the controller facilitates controlling the flow of hydrogen in the hydrogen flow path from start of the fueling at time Tstart to end of the fueling at time Tend. Wherein during a first period from Tstart to T1, the controller facilitates controlling the flow of hydrogen from the high-pressure hydrogen storage via the first path to the nozzle, and wherein during a second period from T1 to Tend, the controller facilitates controlling the flow of hydrogen from the high-pressure hydrogen storage via the second path to the nozzle. Wherein by control of at least part of the valves, the controller establishes a mass flow in the first path higher than a threshold of at least 60 grams per second [g/s], and wherein by control of the high-pressure compressor, the controller establishes a mass flow in the second path lower than the threshold.

The hydrogen fueling station is advantageous in that it has the effect, that it facilitates delivering a high volume of gaseous hydrogen (preferably above 55 Kg) within a short period of time (preferably below 15 minutes). Thereby, the hydrogen fueling station is being attractive to fueling of trucks, busses, trains, aero planes, ships, and/or the like which are all referred to as heavy-duty vehicles.

According to an exemplary embodiment, the threshold value is above 100 g/s, preferably above 125 g/s most preferably above 130 g/s.

This is advantageous in that it has the effect, that as an example 80 Kg of hydrogen gas can be transferred to the tank in only 10 minutes or even 125 Kg of hydrogen gas can be transferred to the tank in only 15 minutes. Accordingly, it is advantageous in that it enables fueling of a fuel cell truck in approximately the same time as fueling of a fossil fuels truck.

According to an exemplary embodiment, the high-pressure hydrogen storage comprises a plurality of individual vessels.

This is advantageous in that it has the effect, that the pressure difference between an individual vessel and the tank can be maintained as high as possible for as long time as possible leading to a period as long as possible with maximum transfer of gaseous hydrogen.

According to an exemplary embodiment, the high-pressure compressor comprises two compressor heads, wherein the two compressor heads are preferably connected in parallel.

To facilitate as high mass flow as possible during the second period the high-pressure compressor should have as high capacity as possible. Therefore, it is advantageous to have a compressor with two heads and in addition to that couple the two heads in parallel in that this would increase capacity with factor two. As an alternative to one compressor, the capacity can be increased by installing two or more compressors. However, this increases cost and food print of the hydrogen fueling station which is not desired.

According to an exemplary embodiment, at least one of the two compressor heads have an oblong shaped compression chamber.

A compressor having an oblong shaped chamber is advantageous in that it has the effect, that such shape increase capacity per KW power used and it increases flexibility including possibility of varying speed of the diaphragm.

According to an exemplary embodiment, the diameter of the pipes constituting the hydrogen flow path is at least 8 mm, preferably 10 mm most preferably 12 mm.

This is advantageous in that it has the effect, that higher diameter of pipes allows high mass flow through the pipe.

According to an exemplary embodiment, the controller is a Programmable Logic Controller controlling at least part of the valves and thereby facilitating by-passing the high-pressure compressor for at least 4 minutes from time Tstart.

According to an exemplary embodiment, the controller establishes flow from the individual vessels of the high-pressure hydrogen storage towards the nozzle in a sequence starting with the one of the vessels having the lowest pressure which is at least 25 bar, preferably at least 75 bar, most preferably at least 100 bar higher than the initial pressure in the tank.

This is advantageous in that using the pressure bank established, during times where no fueling has been made, in the individual vessels of the high-pressure hydrogen storage is the fastest way to transfer mass to the tank. This is at least true as long as the delta pressure between pressure of the high-pressure storage and the tank is in a range of at least 25-125 bar.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 illustrates slopes of different parts of the mass flow characteristic of a fueling made according to an exemplary embodiment,

FIG. 2 illustrates a flow chart of the steps of a fueling according to an exemplary embodiment,

FIG. 3 illustrates part of a hydrogen fueling station and part of a heavy-duty vehicle according to an exemplary embodiment, and

FIG. 4 illustrates a simulation result of a refueling according to the present invention.

### DETAILED DESCRIPTION

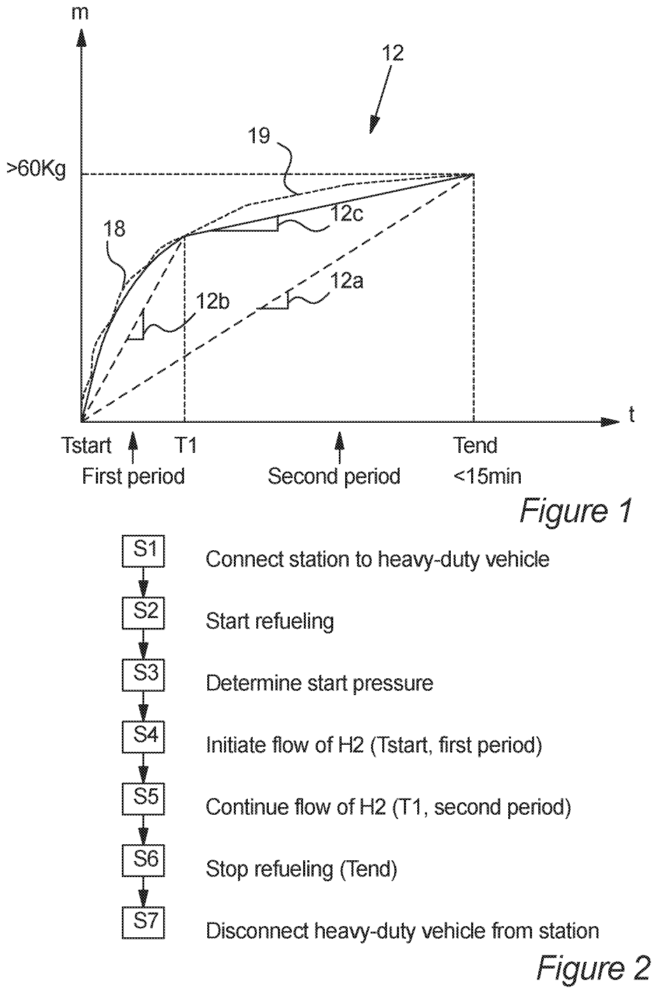

FIG. 1 illustrates the relationship between mass of gaseous hydrogen transferred from a hydrogen fueling station 5 to a heavy-duty vehicle 1 during a fueling. The transfer is illustrated in the form of a mass flow characteristic 12. The fueling starts at time Tstart and ends at time Tend. Time T1 illustrates a point in time between Tstart and Tend where the source of the hydrogen to be transferred changes. It should be mentioned, that the source of the hydrogen here should be understood as either a high-pressure hydrogen storage 6 or a high-pressure compressor 8.

The mass flow characteristic 12 has a total average slope denoted 12a which as indicated is the average slope during the entire fueling from Tstart to Tend. The total average slope 12a is above a threshold of 60 g/s, preferably between 100 g/s and 140 g/s. This is to facilitate a fueling of a truck or train tank 2 having a volume over 1000 L, preferably between 2000 L and 3000 L. A high volume fueling according to the invention transfers over 60 Kg, preferably between 75 Kg and 130 Kg of gaseous hydrogen within a period of time that is less than 20 minutes, preferably between 8 and 18 minutes.

The tank volume depend on the type of vehicle hence, if the vehicle is a truck the tank volume is typically between 1000 L and 3000 L. If the vehicle is a train, the tank volume is typically between 4000 L and 7000 L. It should be mentioned, that even though most embodiments in this application is directed to vehicles, the fueling method may also be applied to ships.

A specific example of an exemplary embodiment is the fueling of 75 Kg of gaseous hydrogen in a 2000 L truck tank 2 within a fueling time of 10 minutes (in this example there will be approximate 5 L hydrogen in the tank when the refueling starts and the tank is a 700 bar rated tank). Another specific example of an exemplary embodiment is the fueling of 124 Kg of gaseous hydrogen in a 5500 L (350 bar rated tank) train tank 2 within a fueling time of 15 minutes. The above ranges and examples should not be understood as limiting for the scope of the disclosure, which depending on hardware configuration facilitates other not mentioned combinations of transferred mass of hydrogen, tank size and fueling periods. Limitations of the volume/time relationship of a fueling in an exemplary embodiment is typically hardware configuration including dimensions of flow path (implemented as pipes and valves), volume and pressure of the high-pressure storage 6 and capacity (in terms of speed of piston and pressure/time relationship) of the compressor 8. Of course, the initial conditions (pressure tank 2) also are important in relation to carrying out the fueling.

The mass flow characteristic 12 is divided at time T1 so as to include a first period between time Tstart and T1 and a second period between time T1 and Tend. As illustrated the average slope of the mass flow characteristic of the first period 12b is higher than the average slope 12a. Further, it is noted that the average slope of the mass flow characteristic of the second period 12c is lower than the average slopes 12a, 12b.

From FIG. 1 it is illustrated, that the average slope is 12c. This however, is only one possible way of controlling the compressor output. Due to the use of the controller 9, it is possible to increase the pressure linear as illustrated by 12c. However, as illustrated by the dotted line 19, during the second period, the compressor 8 may be controlled according to different operation parameters which may create e.g. three different linear sections within the second period together creating an average slope, which in this particular case is the same as line 12c.

Controlling the average slopes 12b and 12c different is desirable, in various exemplary embodiments, to be able to obtain the preferred transfer of mass of gaseous hydrogen within the preferred time. More specific the average slopes 12b and 12c should be as high as possible. The maximum average slope 12b of the first period is determined by the pressure at the high-pressure hydrogen storages 6, more specific the pressure of the individual vessels, the number of these vessels comprised by the high-pressure hydrogen storage 6 (i.e. total volume of the high-pressure hydrogen storage 6) and the initial pressure in the tank 2. The maximum average slope 12c of the second period is determined by the capacity of the high-pressure compressor 8 i.e. the number of compressor heads, inlet pressure, outlet pressure and thereby indirectly the number high-pressure compressors 8, capacity of each head, power available, piston speed, etc.

As indicated, the duration of the first and second periods depend on initial conditions such as temperature in the tank 2 and ambient temperature, start pressure in the tank 2, size of the tank 2, start pressure in the high-pressure hydrogen storage 6, etc.

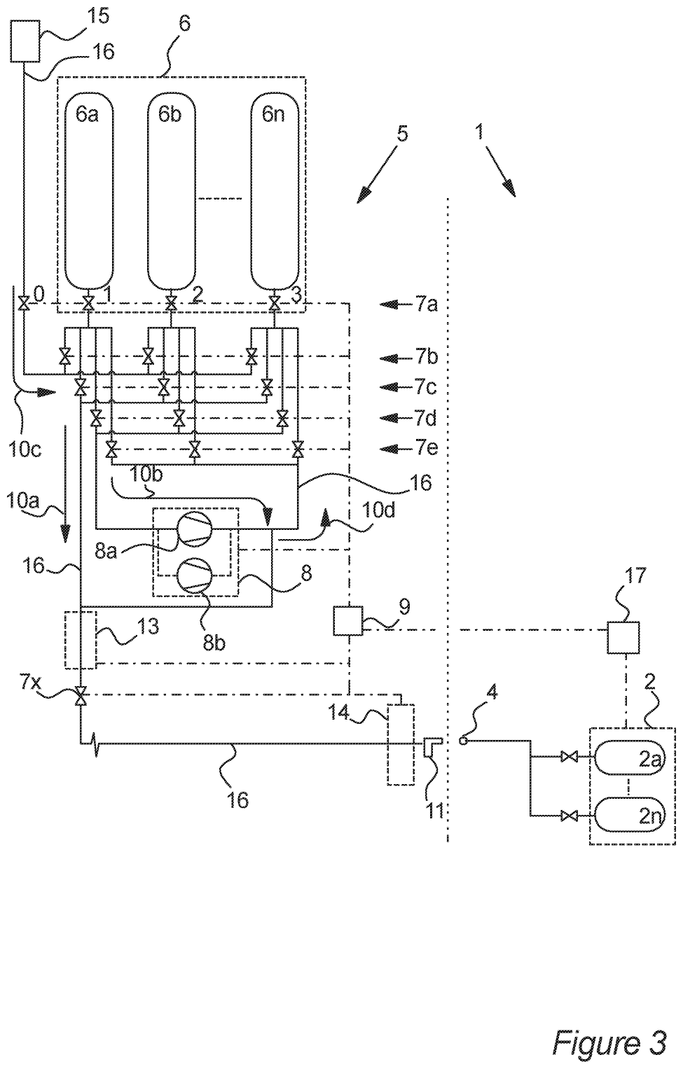

The steps of a fueling according to an exemplary embodiment will now be described with reference to FIG. 2 and FIG. 3. The natural first step Si is to park the heavy-duty vehicle 1 in proximity of the nozzle 11 and connecting the nozzle 11 to the receptacle 4 of the heavy-duty vehicle 1. Thereby is established a hydrogen flow path 10 from the high-pressure hydrogen storage 6 to the tank 2. Then the fueling is initiated S2, preferably by direct or indirect interactions between a user and a communication interface of the hydrogen fueling station 5.

The first step in that actual fueling S3, i.e., transfer of hydrogen from hydrogen fueling station 5 to the heavy-duty vehicle 1, is preferably determining the initial pressure in the tank 2. Known techniques may be used to determine this pressure. It should be mentioned that determining initial pressure is not absolutely necessary. However, due to the logarithmic relationship between pressure and temperature increase, it is for safety reasons advisable to determine this pressure prior to the fueling.

With reference to FIG. 3 it is worth noting, that valves 7a1, 7b1, 7c1, 7d1 and 7e1 regulate flow to and from the vessel 6a. The valves 7a-e controlling flow to and from the vessel 6b are denoted 7a2, 7b2, 7c2, 7d2 and 7e2 and the valves 7a-e controlling flow to and from the vessel 6n are denoted 7an, 7bn, 7cn, 7dn and 7en. The valve denoted 7a0 is controlling the third path 10c from (and to) a supply storage denoted 15. The valve 7x is the main valve which has to be open to allow flow from the high-pressure storage 6 to the tank 2. It should be noted that other not illustrated valves (such as one in the fourth flow path 10d downstream the compressor 8), meters, orifices, sensors, etc. may be installed in the flow paths 10. Note that together the vessels 6a-6n are referred to as high-pressure storage 6.

The fueling is initiated S4 (at Tstart) by establishing a first hydrogen flow path l0a from the high-pressure hydrogen storage vessels 6 to the tank 2 via which as much (as high a volume of) hydrogen as possible is transferred as fast as possible. During this first period, the higher delta pressure between pressure of chosen vessel 6a-6n and the tank 2 the high volume of hydrogen is transferred.

One way of establishing a first flow path 10a includes opening valves 7a1, 7c1 and 7x allowing flow from vessel 6a to tank 2 while keeping the remaining valves illustrated on FIG. 3 closed. The first flow path 10a may also be established with vessel 6b and 6n respectively as hydrogen source. Accordingly, in the first period of time between Tstart and T1, several first flow paths 10a may be established one at the time by selecting source vessel 6a-6n and accompanying valves.

The control of when which vessel 6a-6n should be used as hydrogen source for the first flow path 10a is determined by the controller 9 based on information received by not illustrated pressure (and temperature) sensors measuring values of vessels 6a-6n, pipes 16 and tank 2 before, during and after the fueling. As one can imagine, the control of the source of the first flow path 10a to obtain highest slope 12b is specific for the individual fueling in that it at least depends on pressure in vessels 6a-6n and pressure in the tank 2. But as a rule of thumb the control facilitates over the first period of time an optimal (highest delta pressure) relationship between the individual vessels 6a-6n and the tank 2.

When time T1 is reached the controller 9 changes control strategy from a delta-pressure-based fueling strategy during the first period of time to a compressor-based strategy during the second period of time S5. The time T1 is reached when the delta pressure between the vessel 6a-6n and the tank 2 reaches zero minus a threshold difference. The threshold difference is preferably in the range of 50-150 bar, and more preferably in the range of 75-125 bar, to establish a sufficiently high slope 12b.

During the second period, hydrogen flows from the high-pressure storage 6 to the tank 2 via the second flow path 10b. Like during the first period, the vessel 6a-6n selected as source of hydrogen for the compressor 8 is determined by the controller based on information received by the not illustrated pressure (and temperature) sensors. Based on this information the controller 9 may establish a second flow path 10b from vessel 6a to the tank 2 by opening the valves 7a1, 7d1 and 7x allowing flow from vessel 6a to tank 2 while keeping the remaining valves illustrated on FIG. 3 closed. The second flow path 10b may also be established with vessel 6b and 6n respectively as hydrogen source for the compressor 8. Accordingly, in the second period of time between T1 and Tend, several second flow paths 10b may be established one at a time by selecting source vessel 6a-6n and accompanying valves.

From the above it is noted, that the same vessel 6a-6n may be used as hydrogen source in both the first (Tstart to T1) and the second period of time (T1 to Tend).

The fueling is terminated S6 when a determined state of charge in the tank 2 is reached, when a determined target pressure of hydrogen is transferred to the tank 2 or when a determined period time has passed. These stop criterions may be predetermined, but also determined (and changed) dynamically during the fueling e.g. based on remaining pressure in storage 6, temperature, etc. Further, a user may terminate or the controller 9 may terminate due to safety reasons.

The final step S7 is the disconnection of the nozzle 11 from the receptacle 4 and possible finalizing of financial transactions.

As described, hydrogen flow is controlled by the controller 9 until the state of charge has reached a desired level (preferably 100%) or until a period of time has been used (at Tend). Tend marks the time of end of fueling, but there might still be some post-fueling actions, such as removing the nozzle 11 from the receptacle 4, finalizing payment, checking out of an automated payment or fueling system, etc.

The communication between user and hydrogen fueling station 5 is established via a suitable approach, for example via a user interface of the hydrogen fueling station 5, a mobile device or vehicle to initiate a fueling. The determination of initial pressure in the tank 2, the selection of vessels of the high-pressure hydrogen storage 6 and thereby status of valves 7 is performed by the controller 9. Preferably the controller is an industrial programmable logic controller which in the art is referred to as PLC. It should be mentioned, that the controller 9 may be implemented as one or more PLCs one of which may be what in the art is referred to as a safety controller. Such controller/control system for a hydrogen fueling station is described in detail in US patent application publication US2017-0248975 entitled “Control System for a Hydrogen Refuelling Station” which is hereby incorporated by reference in its entirety for all purposes (except for any subject matter disclaimers or disavowals, and except to the extent that the incorporated material is inconsistent with the express disclosure herein, in which case the language in this disclosure shall control).

Beside the control related to safety including heat and leakage control, the controller 9 also controls the valves 7 and thereby at which vessels 6a-6n the hydrogen flow path 10 should start at the beginning of the fueling (at Tstart), when it is time to change vessel 6a-6n, when it is time to change from the first flow path 10a to the second flow path 10b (at T1) and when to terminate the fueling (at Tend).

Now turning to FIG. 3, illustrating main elements of a hydrogen fueling station 5 according to an exemplary embodiment. As illustrated several hydrogen flow paths 10a, 10b, 10c together referred to as 10 comprises a plurality of pipes 16 and valves together referred to by 7 enabling connection of the high-pressure hydrogen storage 6 and the nozzle 11.

The hydrogen flow path 10c including pipes 16 and valves 7a0, 7b1, 7b2 and 7bn enables connection of the hydrogen supply 15 to the high-pressure hydrogen storage vessels 6a-6n referred to as third flow path 10c. The hydrogen supply 15 may be a truck trailer, an electrolyzing unit producing hydrogen on site, hydrogen network, or any other suitable hydrogen supply. It should be noted that the hydrogen supply 15 might be used as source in both the first and second periods during the fueling.

Finally, the hydrogen flow path 10 also includes pipes 16 and valves 7 enabling a connection of the hydrogen supply 15 and the individual vessels 6a-6n with the high-pressure compressor 8. This connection is referred to as fourth flow path 10d. In this way, it is possible to reload the vessels 6a-6n with hydrogen from the hydrogen supply 15 via the compressor 8. Reload should be understood as increasing hydrogen density/pressure in the vessels 6a-6n.

Accordingly, by controlling the valves 7, the controller 9 facilitates control of the flow of hydrogen via flow paths 10 including the first, second, third and fourth flow paths 10a, 10b, 10c, 10d. This allows flow inside the hydrogen fueling station 5, from (and between) supply 15 and storage 6 and from supply 15 and storage 6 to nozzle 11 and thereby tank 2. The control of the flow of hydrogen in the flow paths 10 may be optimized so as to increase the slope of the mass flow characteristics 12b of the first period (preferably above 180 g/s) and thereby reach the slope of the total mass flow characteristics 12a (preferably above 120 g/s).

The high mass flow in the flow path 10 is possible in that the valves 7 and pipes 16 are dimensioned accordingly and may be dimensioned to allow a mass flow of up to and even above 250 g/s. Accordingly, the pipes 16 may be of a stainless steel type having a diameter in the range of 8-12 mm, preferably 10 mm.

In the following exemplary embodiments related to flow path control during a fueling and between two subsequent fuelings will be described.

One simplified and not limiting example of establishing a mass flow characteristic having an average slope 12a higher than or equal to a threshold of 60 g/s for a period of e.g. 10 minutes is by starting at the compressor 8. If the maximum capacity of the compressor 8 is 20 g/s, then this is the average slope of the mass flow characteristic 12c during the second period. Accordingly, during the first period the average slope of the mass flow characteristic 12b have to be 100 g/s.

From FIG. 1 it is indicated by the dotted line 18, that during the first period, the flow of hydrogen from the vessels 6a-6n originates from either one individual vessel or from one group vessel 6a-6n at the time. The dotted line 18 illustrates that four vessels are used in that four small “waves” are illustrated indicating that when pressure starts to decrease in one vessel (indicated by the decreasing slope parts of the dotted line 18), the source vessel is changed to another vessel having a higher pressure, thereby increasing the delta pressure (indicated by the increasing slope parts of the dotted line 18).

As described, bank shift (change of vessel 6a-6n) during the first period is made when the pressure of the vessel 6a-6n used as source is in the range of 20 to 150 bar such as 25-50 bar or 100 bar. The fueling during the first period includes successive bank shifts and continues until the pressure in the vessel having the highest pressure of the vessels of the high-pressure hydrogen storage 6 is reduced to a pressure equal the pressure in the tank 2, or at least with a range of such pressure, e.g., within about 25-100 bar. At this point what is referred to as time T1 has been reached.

The preferred initial pressure of the vessels 6a-6n in an embodiment, is 500-725 bar prior to starting a fueling. This level may differ depending on the compressor 8. Hence, if the inlet pressure of the compressor cannot exceed 500 bar, 500 bar would be a suitable initial pressure. Similar, if the maximum pressure the compressor 8 is able to deliver is 725 bar, then 725 bar could be a suitable initial pressure. With this said, the higher pressure in the vessels 6a-6n, the higher slope 12b it is possible to establish.

In periods between subsequent fuelings, the controller 9 facilitates reload of the vessels 6a-6n. The pressure control of the vessels 6a-6n of the high-pressure hydrogen storage 6 is considered as an additional layer on top of the above described fueling between time Tstart and Tend. During the entire fueling the choice of vessels 6a-6n used as sources may be influenced by this reload/dump off strategy. The purpose of the reload/dump off strategy is 1) always be ready to start a fueling and 2) establish as low pressure in those of the vessels 6a-6n which are to be reloaded with hydrogen e.g. from a swap truck trailer.

One way of achieving the reload strategy is to ensure that if the vessel 6a is a swap truck trailer, then at the time of replacement, the density or pressure of hydrogen in this vessel, should be as low as possible. Thereby is achieved that hydrogen is not delivered back to the central hydrogen storage/electrolyzer. The low pressure in the vessel 6a, can be established either during the second period of the fueling by using it as source of the compressor 8. Alternatively, between fueling, the compressor may reload vessel 6b with hydrogen from vessel 6b and thereby emptying vessel 6a.

Further, always being ready to refuel can be facilitated by having a vessel 6c (not illustrated) pointed out as “fueling storage” and ensuring that the pressure hereof is always as high as possible. This can be obtained by emptying the other vessels 6a-6n by reloading vessel 6c with hydrogen here from.

Hence by the reload strategy, the time of dump off of hydrogen from a supply 15 e.g. a truck trailer to a permanent vessel of the storage 6 is reduced. Further, fueling can always be made from the fueling storage, not necessarily by using the fueling storage as the first source of hydrogen during a fueling, but the high pressure (e.g. 1000 bar) helps to establish the desired high slope 12b.

Returning to FIG. 3, it is further indicated that the hydrogen fueling station 5 also comprises a cooling system 13. Cooling the hydrogen prior the entering the tank 2 is the preferred way of facilitating heat control of hydrogen in the tank 2 and thereby compensating for the temperature increase inherent in the pressure increase happening during the fueling. The cooling system 13 may be controlled by the controller 9 and may by implemented as any known and suitable cooling systems/methods.

The cooling system 13 is relevant to include in that the higher temperature of the gas in the vehicle tank the higher pressure is needed to reach the desired state of charge (typically 100% SOC). Hence, a trade off has to be made between the high flow in the first period of the refueling leading to increased temperature and thereby higher pressure to reach 100% SOC but faster fueling time and the time of the compressor is used during the second period. Using the compressor increases the fueling time, however the temperature is not increased as much as in the first period in that the flow is not that high, so the pressure to reach 100% SOC is not increased as much as in the first period. Summing up, the trade off is between fast fueling during the first period leading to a higher pressure to reach 100% SOC and the slower refueling by the compressor leading to longer refueling time but lower pressure at 100% SOC.

Further it is noted, that the nozzle 11 is part of a dispenser 14. The dispenser 14 may be built into the hydrogen fueling stations main module (where storage 6, compressor 8, controller 9, etc. preferably is located) or separated from such main module by up to 50 to 60 meters or even more. Separating the dispenser 14 from the main module(s) may be desired if it has to be possible to refuel the heavy-duty vehicle 1 at an existing fueling station. Where at the existing fueling station there is not sufficient free space for the main module(s) to facilitate parking the heavy-duty vehicle at a desired location 1 during fueling.

Further, it is noted that the compressor 8 may include more than one heads or implemented as one or more compressors 8a, 8b. A multi-head compressor 8 may be implemented as one physical compressor having more than one head or e.g. two physical compressors located next to each other. It is naturally desired to have one compressor with more than one head in that the footprint of one compressor is less than the footprint of two compressors. The compressor 8 can be a standard industrial compressor or a compressor having an oblong shaped compression chamber. The latter has several advantages including higher speed and thereby higher capacity per unit energy consumed. Such compressor is described in international patent application publication number WO2016184468 entitled “Diaphragm Compressor With an Oblong Shaped Chamber” which is hereby incorporated by reference in its entirety for all purposes (except for any subject matter disclaimers or disavowals, and except to the extent that the incorporated material is inconsistent with the express disclosure herein, in which case the language in this disclosure shall control).

From the above it is clear, that what in the present disclosure is referred to as a “heavy-duty vehicle” 1 is not a car and hence what is referred to as “fueling” is not comparable to a fueling complying with the requirements of the SAE J2601 fueling protocol. Due to the large hydrogen storage 2 of a heavy-duty vehicle, having volumes over 1000 L and closer to 2000-2500 L for a truck and to 5000 L for a train, a fueling of a heavy-duty vehicle with 80 Kg of hydrogen following SAE J2601 would take up to 40 minutes or even more.

As illustrated on FIG. 3, the tank 2 may be divided in one or more vessels 2a-2n to reach the high volume. No matter how such high volume is reached the total surface of the tank 2 is large and therefore helping to distribute heat created during the fueling compensating for the heat generated as consequence of the pressure increase.

In case the tank 2 comprise more than one vessel 2a-2n these vessels are preferably coupled in parallel and therefore receiving equal volume of hydrogen during the fueling. It should be mentioned, that it may be possible to control the flow path so that the individual vessels are connected hereto one by one or one group at the time. In this way the receiving vessel or group of receiving vessels are changing during the fueling.

The station controller 9 preferably communicates with a heavy-duty vehicle controller 17. Such communication is preferably bidirectional and communication from the heavy-duty vehicle controller 17 may include signals indicating status (ready to receive hydrogen), tank temperature, tank pressure, tank type, tank volume, etc. Communication from the station controller 9 may include start and stop of fueling, total volume of hydrogen transferred, etc. Preferably the communication is implemented using a wireless communication protocol such as based on IR or RF communication.

From the above, it is now clear that the an exemplary embodiment relates to a hydrogen fueling station 5 and a method of fueling which enables very high mass flow, namely a mass flow above a threshold of 60 g/s. Such high mass flow is obtained by dividing the fueling in at least two parts, where during the first part, the mass flow preferably is above 150 g/s or even above 200 g/s whereas during the second part, the mass flow is preferably below 40 g/s. As mentioned, the high mass flow during the first part is established via the first flow path 10a establishing direct connection between one or more supply storage vessels 6a-6n and one or more tanks 2a-2n. Hence, during this part of the fueling the delta pressure between storage vessel 6a-6n and the tank 2a-2n is determining for the amount of hydrogen which is transferred. Further, as mentioned the lower mass flow during the second part is established via the second flow path 10b establishing a connection between one or more supply storage vessels 6a-6n and one or more tanks 2a-2n via the compressor 8. Hence, during this part of the fueling the compressor establishes the delta pressure creating flow of pressure from the compressor 8 (hydrogen storage vessels 6) to the heavy-duty vehicle tank 2.

Accordingly, principles of the present disclosure are advantageous in that it has the effect, that it facilitates fueling of up to or even more than 80 Kg to 125 Kg of gaseous hydrogen within a period of 10 minutes to 15 minutes. The first period between Tstart and T1 of a fueling of 10 minutes may have a duration of 3-4 minutes.

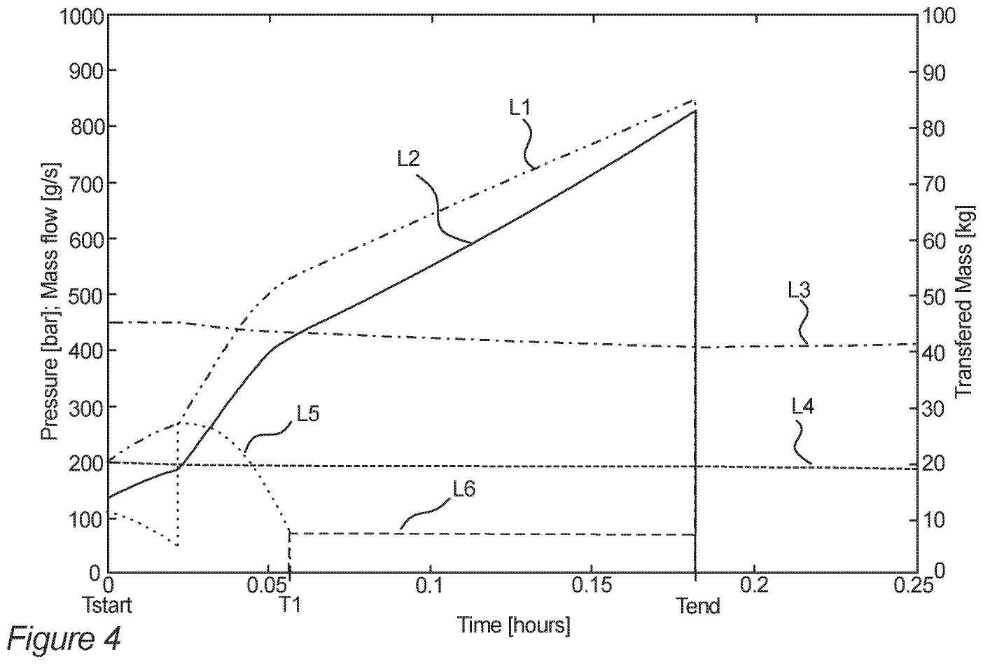

FIG. 4 illustrates a simulation of a fueling of a truck tank. From line L1 it is noted, that at the beginning of the fueling Tstart, the tank comprised 20 Kg of hydrogen and at the end of the fueling Tend, the tank comprised 85 Kg i.e. during the fueling a total mass of 65 Kg was transferred from the hydrogen storage to the vehicle tank in approximate 11 minutes.

Line L2 illustrates the pressure in the vehicle tank, line L3 illustrates the pressure in a 450 bar part of the hydrogen storage and line L4 illustrates the pressure in a 200 bar part of the hydrogen storage. Line L5 illustrate the mass flow during the first period of the fueling i.e. the part from Tstart to T1. The 200 bar part of the hydrogen storage in this embodiment may include more than one physical vessel preferably all having the same pressure at maximum 200 bar. Similar, the 450 bar part of the hydrogen storage in this embodiment may include more than one physical vessel preferably all having the same pressure at maximum 450 bar.

The mass flow from the 200 bar vessel(s) to the truck tank starts from just above 100 g/s and ends at 50 g/s. Subsequently, the mass flow from the 450 bar vessel(s) to the truck tank starts from approximate 270 g/s and ends at approximate 75 g/s at time T1. Hence, line L4 illustrates the cascade fueling method used during the first period of the fueling of the truck tank.

The second part of the fueling is conducted by the direct fill method illustrated by line L6. The mass flow from this second period of the fueling is more or less constant around 75 g/s towards the end of the fueling at Tend.

The line L6 has a tendency to decrease caused by the reduced inlet pressure i.e. the decreased pressure of the 200 bar and/450 bar storages vessels. This as well as the pressure decrease of the 200 bar and 450 bar hydrogen storage parts may be delayed or the speed of the reduction may be decreased by using a second compressor to consolidate the pressure in the vessels of the hydrogen storage. Such second compressor can during the fueling increase pressure in the vessels of the hydrogen storage.

1. A method of fueling a tank of a heavy-duty vehicle with a gaseous hydrogen fuel, wherein a mass flow from a high-pressure hydrogen storage of a hydrogen fueling station to the tank is following a mass flow characteristic from a start of the fueling at a time Tstart to an end of the fueling at a time Tend, the method comprising:
controlling, by a controller of the hydrogen fueling station, a slope of the mass flow characteristic between the time Tstart and Tend according to a first and a second fueling method,
wherein the mass flow is established during a first period of time between Tstart and T1 by a pressure difference between a pressure of the hydrogen gas stored in the high-pressure hydrogen storage and a pressure in the tank of the heavy-duty vehicle,
wherein the mass flow is established during a second period of time between T1 and Tend by a compressor having an inlet fluidly connected to the high-pressure hydrogen storage and an outlet fluidly connected to the tank of the heavy-duty vehicle,
wherein an average slope of the mass flow during the first period of time is higher than an average slope of the mass flow during the second period of time.

2. The method according to claim 1, wherein the average slope of the mass flow characteristic between Tstart and Tend of the mass flow characteristic is higher than a defined threshold of at least 60 grams per second [g/s], wherein the average slope of the mass flow characteristic during the first period from Tstart to T1 is higher than the average slope between Tstart and Tend, and wherein the average slope of the mass flow characteristic during a second period from T1 to Tend is lower than the average slope between Tstart and Tend.

3. The method according to claim 2, wherein the threshold value is above 100 g/s.

4. The method according to claim 1, wherein the average slope of the mass flow characteristics of the first period is at least 4 times higher than the slope of the mass flow characteristics of the second period.

5. The method according to claim 2, wherein the threshold value is predetermined for a predetermined type of vehicle tank.

6. The method according to claim 1, wherein the tank of the heavy-duty vehicle is a truck tank having a total volume above 1000 liters.

7. The method according to claim 1, wherein the tank is a train tank having a total volume above 4000 liters.

8. (canceled)

9. (canceled)

10. The method according to claim 1, wherein a vessel of the high-pressure hydrogen storage used as source of hydrogen gas in the first period is subsequently used as hydrogen source in the second period.

11. The method according to claim 10, wherein the controller establishes flow from the individual vessels of the high-pressure hydrogen storage towards a nozzle in a sequence starting with the one of the vessels having the lowest pressure which is at least 25 bar higher than the initial pressure in the tank of the heavy-duty vehicle.

12. The method according to claim 1, wherein the compressor facilitates supplying gaseous hydrogen fuel to the tank of the heavy-duty vehicle with at least an average between 50 g/s and 100 g/s during the second period from T1 to Tend.

13. (canceled)

14. (canceled)

15. (canceled)

16. The method according to claim 1, wherein the method further comprises a step of removing a nozzle from a receptacle after the time Tend.

17. The method according to claim 10, wherein the hydrogen source during the first period is refilled.

18. The method according to claim 1, wherein an additional compressor, during fueling of a vehicle tank, is performing pressure consolidation of a vessel of the hydrogen storage.

19. A hydrogen fueling station facilitating fueling a tank of a heavy-duty vehicle having a total volume above 1000 liters with a gaseous hydrogen fuel, the hydrogen fueling station comprising:
a high-pressure hydrogen storage,
a high-pressure compressor,
a controller, and
a hydrogen flow path from the high-pressure hydrogen storage to a nozzle connectable to a receptacle of the heavy-duty vehicle,
wherein the hydrogen flow path comprises a first path by-passing the high-pressure compressor and a second path connecting the high-pressure compressor to the high-pressure hydrogen storage,
wherein the controller facilitates controlling a flow of hydrogen in the hydrogen flow path from a start of the fueling at a time Tstart to an end of the fueling at a time Tend,
wherein during a first period from Tstart to T1, the controller facilitates controlling the flow of hydrogen from the high-pressure hydrogen storage via the first path to the nozzle, and
wherein during a second period from T1 to Tend, the controller facilitates controlling the flow of hydrogen from the high-pressure hydrogen storage via the second path to the nozzle,
wherein by control of at least part of valves, the controller establishes a mass flow in the first path higher than a threshold of at least 60 grams per second [g/s], and
wherein by control of the high-pressure compressor, the controller establishes a mass flow in the second path lower than the threshold.

20. The hydrogen fueling station according to claim 19, wherein the threshold value is above 100 g/s.

21. (canceled)

22. The hydrogen fueling station according to claim 19, wherein the high-pressure compressor comprises two compressor heads, wherein the two compressor heads are preferably connected in parallel.

23. The hydrogen fueling station according to claim 22, wherein at least one of the two compressor heads have an oblong shaped compression chamber.

24. The hydrogen fueling station according to claim 19, wherein a diameter of pipes constituting the hydrogen flow path is at least 8 mm.

25. The hydrogen fueling station according to claim 19, wherein the controller is a Programmable Logic Controller controlling at least part of the valves and thereby facilitating by-passing the high-pressure compressor for at least 4 minutes from time Tstart.

26. The hydrogen fueling station according to claim 19, wherein the controller establishes flow from the individual vessels of the high-pressure hydrogen storage towards the nozzle in a sequence starting with the one of the vessels having the lowest pressure which is at least 25 bar higher than the initial pressure in the tank.
